(19) United States
(12) Patent Application Publication
(10) Pub. No.: US 2017/0200220 A1
(43) Pub. Date: Jul. 13, 2017

(54) PERFORMANCE OF A REMOTELY MANAGED CUSTOMER SERVICE SYSTEM

(71) Applicant: Tangerine Bank, Toronto (CA)

(72) Inventors: Mark Nicholson, Stouffville (CA); Vinay Venugopal, Maple (CA)

(21) Appl. No.: 15/401,836

(22) Filed: Jan. 9, 2017

Related U.S. Application Data
(60) Provisional application No. 62/275,979, filed on Jan. 7, 2016.

(51) Int. Cl. G06Q 40/02; G06Q 30/02; G06F 3/0484; G06Q 10/10

(52) U.S. Cl. CPC G06Q 40/02; G06Q 10/1093; G06Q 30/0282; G06F 3/04847; G06T 11/001

(57) ABSTRACT

A method of improving customer management system are provided. A customer's financial retrieved from banking sources and questionnaire responses are used to generate a key performance indicator and a monthly budget. A temperature color indicator is displayed based on the key performance indicator, indicating whether a customer is on track to meeting their financial goals. A sandbox is provided for testing various hypothetical scenarios. The customer service representative allocated to a client may be recommended based on mode of communication and past rating by the client of the representative.

### CROSS-REFERENCE TO PRIOR APPLICATIONS

This application claims priority from U.S. provisional application No. 62/275,979 filed on Jan. 7, 2016, herein incorporated by reference in its entirety.

### FIELD OF THE INVENTION

The present invention relates generally to remotely managing customer experience. More particularly, the present invention relates to a system for profiling behavior of a customer and providing performance feedback with respect to one or more goals.

### BACKGROUND OF THE INVENTION

Recently, many customers are using mobile phones and applications executing thereon and prefer to interact with financial providers in this manner. Furthermore, customers increasingly desire a customized experience tailored to the customer needs and goals.

It is an object of this invention at least to provide a novel method and system for profiling behavior of a customer and providing performance feedback with respect to one or more goals.

### SUMMARY OF THE INVENTION

According to one aspect of the invention, there is provided a method of improving a customer management system. The method comprises: retrieving financial data, for a customer, from a plurality of sources; presenting a questionnaire to the customer and receiving responses to the questionnaire including financial goals; generating a key performance indicator, based on the financial data and the financial goals, the key performance indicator comprising a plan financial position line and an actual financial position line, on a time scale between a present time and a time associated with one of said financial goals; generating a temperature color indicator representing a difference between the actual financial position and the planned financial position; and determining a monthly budget based on a duration between the present time and the time associated with the one of said financial goals.

The questionnaire may be generated based on missing information in the financial data. The method may also include sending login credentials to a plurality of online financial websites for gaining access thereto for retrieving the financial data. The temperature color indicator may: display red when the actual financial position is significantly lower than the plan financial position; display orange when the actual financial position is moderately lower than the plan financial position; display yellow when the actual financial position is trivially lower than the plan financial position; display light green when the actual financial position is substantially equal to the plan financial position; and display dark green when the actual financial position is higher than the plan financial position. The receiving of financial data may be repeated periodically in real-time, and the temperature color indicator may be updated based on the financial data. The method may also comprise displaying a calendar view including: a plurality of planned daily spending amounts; a plurality of actual daily spending amounts; and one or more recurring transactions. The plurality of planned daily spending amounts may be based on the monthly budget and based on the one or more recurring transactions. The plurality of planned daily spending amounts and the plurality of actual daily spending amounts may be displayed as bar graphs.

The method of improving a customer management system may further comprise: displaying a scenario sandbox including at least one slider control for increasing income, and a graphical representation of the financial goals may be slid towards the present time on the plan financial position line. The method may also include receiving and storing the customer's preferred mode of communication with a customer service representative; receiving and storing a rating by the customer of one or more of a plurality of customer service representatives; and when the customer contacts customer service, he/she is presented with a choice of customer service representatives based on: the available mode of communication that each one or more of the plurality of customer service representatives supports; and the rating by the customer rating of each of the one or more of the plurality of customer service representatives.

In another aspect of the present invention , there is provided a system for improving performance of a customer management system, comprising: an electronic network in communication with a client computing device and a provider server. The provider server may comprise: a wired transceiver in communication with the network; and a provider processing structure reading and executing instructions from a computer-readable medium. The instructions may comprise a profile engine. The profile engine: retrieves financial data for a customer from a plurality of sources; sends a questionnaire for display on the client computing device; receives from the client computing device, responses to the questionnaire including a plurality of financial goals. The profile engine also generates a key performance indicator based on the financial data and the financial goals. The key performance indicator comprises a plan financial position line and an actual financial position line, on a time scale between a present time and a time associated with one of the plurality of financial goals. The profile engine also generates a temperature color indicator representing a difference between the actual financial position line and the plan financial position line; and determines a monthly budget based on a duration between the present time and the time associated with the one of the plurality of financial goals. The client computing device comprises a network transceiver in communication with the network; and a client processing structure reading and executing instructions from a computer-readable medium. The instructions comprise: instructions for receiving and displaying the questionnaire, instructions for obtaining, from the customer, responses to the questionnaire and transmitting the responses to the provider server over the network, instructions for displaying the key performance indicator, and instructions for displaying the temperature color indicator.

The profile engine may generate the questionnaire based on missing information in the financial date. The profile engine may send login credentials to a plurality of online financial websites for gaining access thereto for retrieving the financial data. Displaying the color temperature indicator may comprise: displaying red when the actual financial position is significantly lower than the plan financial position; displaying orange when the actual financial position is moderately lower than the plan financial position; displaying yellow when the actual financial position is trivially lower than the plan financial position; displaying light green when the actual financial position is substantially equal to the plan financial position; and displaying dark green when the actual financial position is higher than the plan financial position.

The profile engine may retrieve financial data periodically in real time. Displaying the temperature color indicator may comprise updating the temperature color indicator based on the financial data. The instructions executed on the client computing device may further comprise instructions for displaying a calendar view. The calendar view may includes: a plurality of planned daily spending amounts; a plurality of actual daily spending amounts; and one or more recurring transactions. The plurality of planned daily spending amounts may be based on the monthly budget and on the one or more recurring transactions. The plurality of planned daily spending amounts and the plurality of actual daily spending amounts may be displayed as bar graphs.

The instructions executed on the client computing device may further comprise instructions for displaying a scenario sandbox including at least one slider control for increasing income. A graphical representation of the financial goals may be slid towards the present time on the plan financial position.

The profile engine may: receive and store the customer's preferred mode of communication with a customer service representative; receive and store a rating by the customer of one or more of a plurality of customer service representatives. The instructions executed on the client computing device may further comprise instructions for presenting the customer with a choice of customer service representatives based on: the available mode of communication that each one or more of the plurality of customer service representatives supports; and the rating by the customer of the one or more of the plurality of customer service representatives.

### BRIEF DESCRIPTION OF THE DRAWINGS

An embodiment will now be described, by way of example only, with reference to the attached Figures, wherein:

FIG. 1 shows a conceptual overview of the components of a customer management system;

FIG. 2 shows a system overview of a computing network that may be used to implement various parts of the invention;

FIG. 3 shows a client computing system of the customer management system;

FIG. 4 shows a provider computing system of the customer management system;

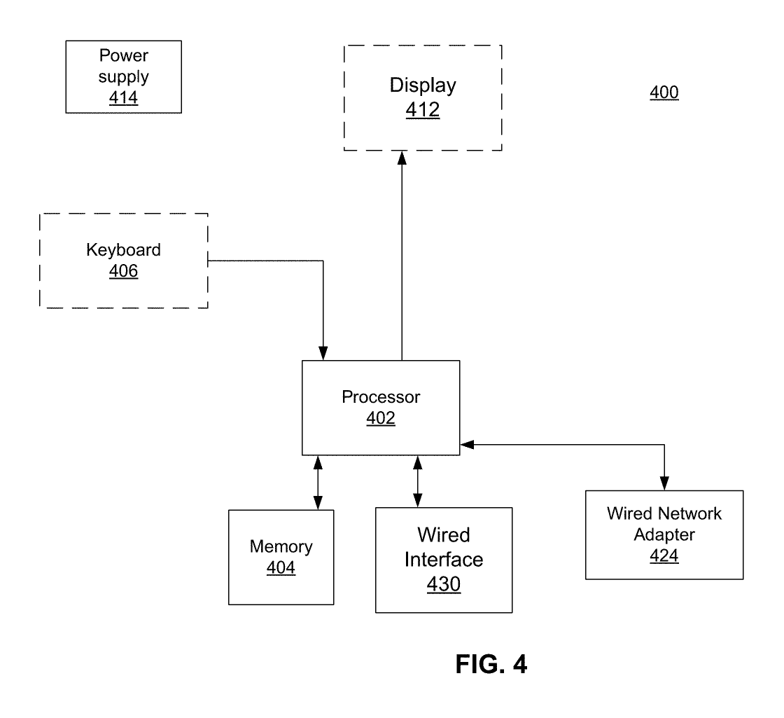

FIG. 5 shows a conceptual diagram of a profile engine of the customer management system;

FIG. 6A shows a conceptual diagram of a performance tracking monitor of the customer management system;

FIG. 6B shows a conceptual diagram of a temperature indicator of the customer management system;

FIG. 6C shows a conceptual diagram of a goals indicator of the customer management system;

FIG. 7 shows a conceptual diagram of a client dashboard of the customer management system;

FIG. 8 shows a conceptual diagram of a client communication customization engine of the customer management system; and

FIG. 9 shows a conceptual diagram of a client support manager of the customer management system.

### DETAILED DESCRIPTION OF THE EMBODIMENTS

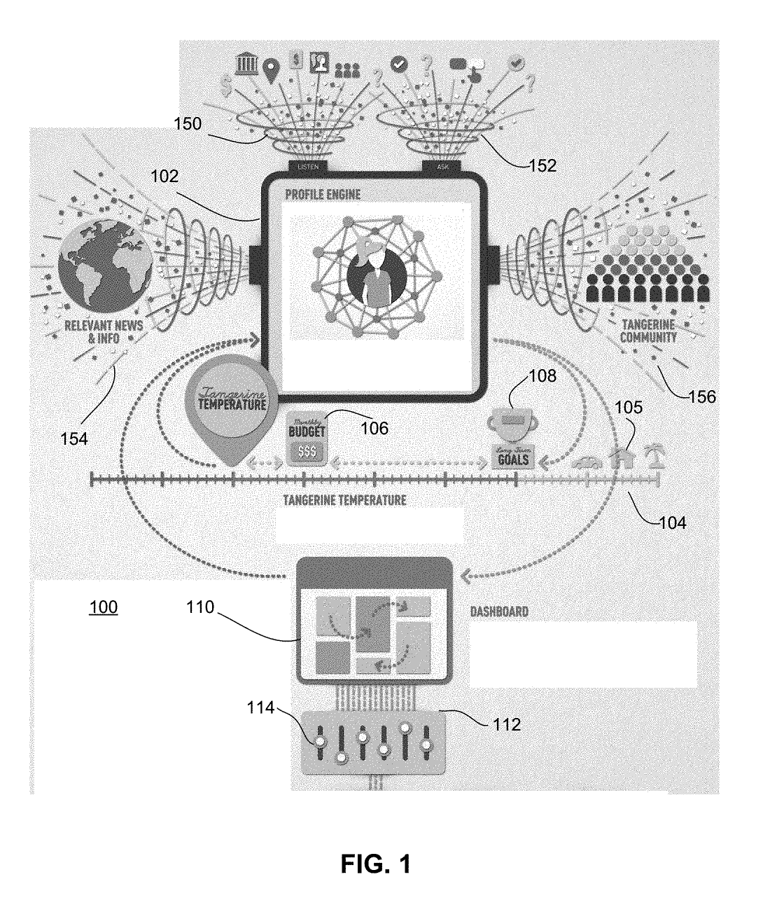

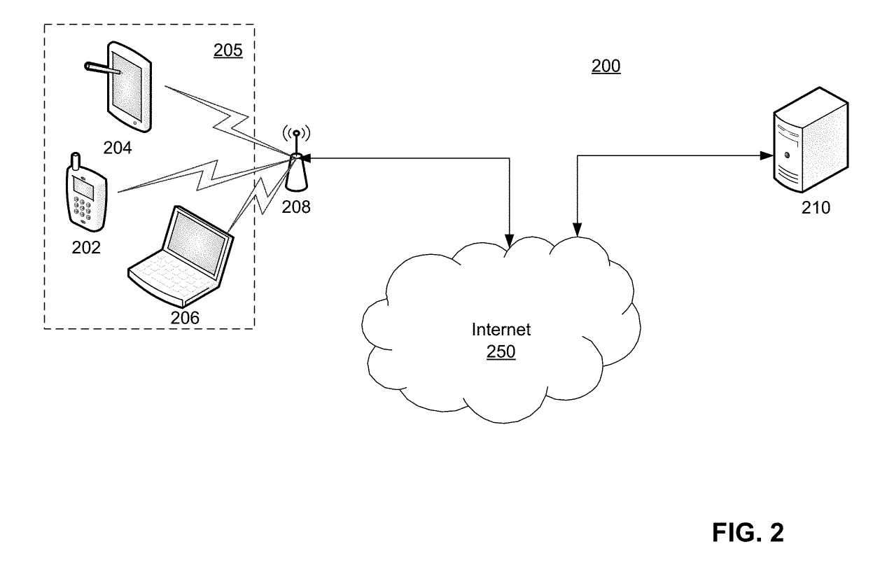

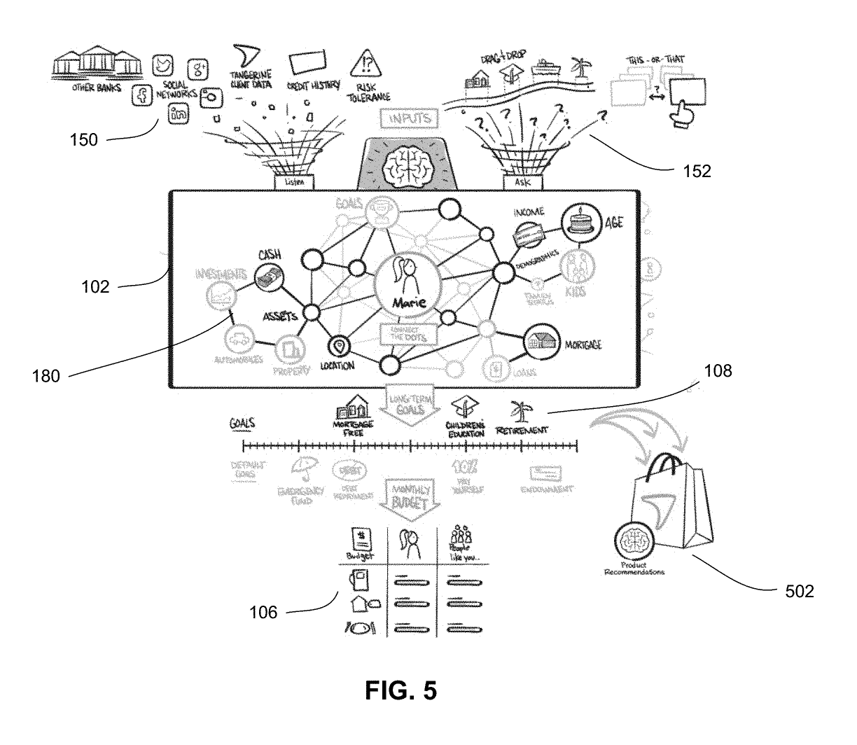

With reference to FIG. 1, a customer management system 100 comprises a profile engine 102, a dashboard 110 which comprises a user interface, and a client communication customization engine 112, which may comprise a user interface. With reference to FIG. 2, dashboard 110 may be displayed on the screen of a client device 205, which may be a tablet 204, a smart phone 202, or a laptop computer 206. The profile engine may comprise a server application running on server 210, and may be in communication with a number of client devices 205 using a secure connection over the Internet 250. Turning back to FIG. 1, the profile engine 102 accumulates client data 150 using at least one retrieval method. For example, the profile engine 102, shown in more detail in FIG. 5, retrieves client data 150 from various sources. For example, client data 150 may be financial data, banking data (from current bank and other banks), location tracking information, spending data, earning data, social network data, friend data, etc. that the client has granted permission to the profile engine 102 to access, for example using the user interface of dashboard 110. For example, the client may provide, using dashboard 110, login credentials to online banking websites of various banks, online brokerages, and the like. The credentials may then be sent, securely, to profile engine 102, so that profile engine 102 may download financial data related to the client. The financial data includes: account balances, debits and credits, earnings, bill payments, credit card debt, line-of-credit balance, and other recurring debits such as mortgage and rent, and recurring credits such as rental income. The client may also provide social networking login credentials such as login credentials for Facebook™, LinkedIn™, Twitter™, and Google Plus™. This allows the profile engine 102 to obtain information about the user and their friends, such as their professional field of employment, and accordingly their average income. Location tracking information may be obtained from a GPS module on client device 205, or entered by the client on dashboard 110 and sent to the profile engine 102. The client location may be used for many purposes such as estimating real-estate prices, automobile prices, inflation rate, interest rates, average income, demographics, and the like. Client data may also comprise the client's risk tolerance. The client risk tolerance may be obtained from any of the client's online banking or investment accounts, determined based on the client's profile information such as age, income, and goals, or requested from the client as part of a questionnaire 152 as explained below. The data obtained and used by the profile engine 102 may be stored internal or external to the customer management system 100. For example, the data may be stored on a database system integral with the profile engine or in a separate system linked to the profile engine via a secure network connection.

The profile engine 102 also retrieves client data by asking the client one or more survey questions 152. These survey questions may be a standard set of questions or may be dynamically generated based on the already accumulated profile data, or a combination of both. For example, a first set of generic survey questions 152 may be generated the first time the client uses the system. Then a subsequent set of survey questions may be designed to prompt the client to add unknown personal attributes such as risk tolerance, and expected milestones such as home purchase, marriage, etc. The questions may be presented in a manner where the client is able to drag and drop objects to formulate answers. For example, in setting goals, the user may drag a virtual representation of a real asset, such as a car, a house, or a vacation, into a life roadmap. Similarly, the client may drag goals 108 onto the roadmap at any time, outside the survey. The goals may also be a certain level of income, a certification, or a graduate degree. Moreover, the profile engine 102 retrieves relevant news and information data 154 based on the client profile data. For example, if profile engine 102 has downloaded, with the client's permission, the client's stock portfolio from the client's online brokerage account, news about the relevant stocks may be retrieved by the profile engine. The information may provide insight as to whether the client will meet their long-term and short-term financial goals. For example, negative news about a stock that represents a significant position in the client's portfolio may impact short-term goals, or retirement goals. Recurring negative news in stocks may also signal that perhaps a client's portfolio needs to be balanced, or that the portfolio needs a higher percentage of fixed income investments. Other members of the client community using the customer management system 100 may also provide information 156 to the profile engine 102. Information from members of the client community 156 may comprise demographics, career, net worth, investment goals, or geographical location.

The profile engine 102 utilizes one or more of elements 150, 152, 154, and 156 and aggregates all of the client profile data to form connections 180, best seen in FIG. 5. The profile engine 102 then analyzes these connections 180, and presents the client with recommendations based on heuristic rules to assist the client in picking realistic long-term goals 108 and formulating an optimal monthly budget 106 based on comparisons to information on similar individuals from the client community information 156. Based on the goals and time horizon, risk tolerance, etc. the profile engine 102 suggests a mix of financial products 502 to achieve the client's objectives. The profile engine 102 monitors the customer profile data and updates the suggestions accordingly. The monitoring and reporting may be conducted on a periodic basis such as daily, weekly, monthly, quarterly, annually, etc.

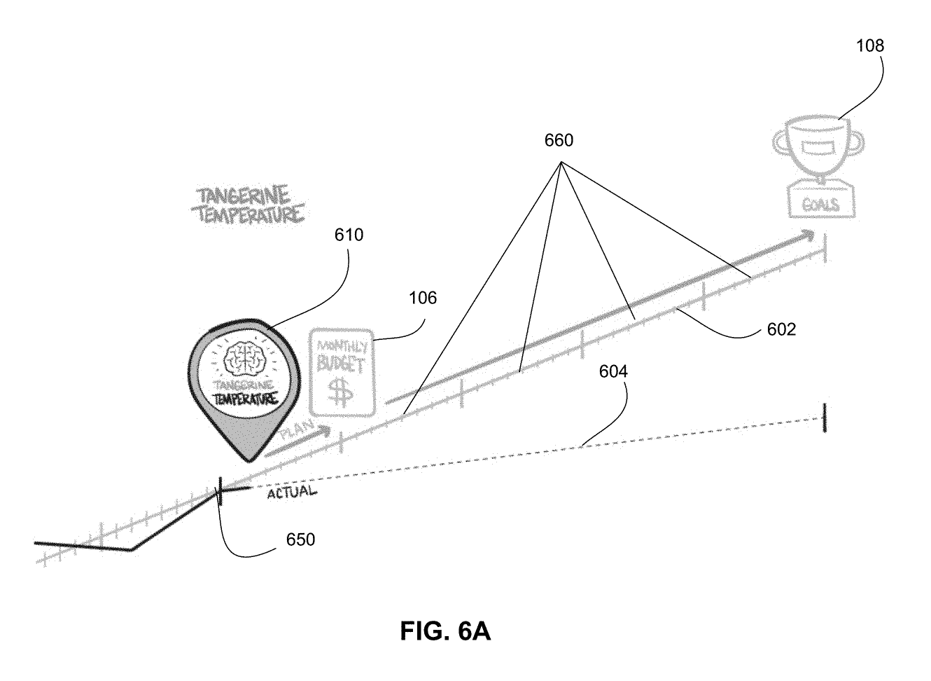

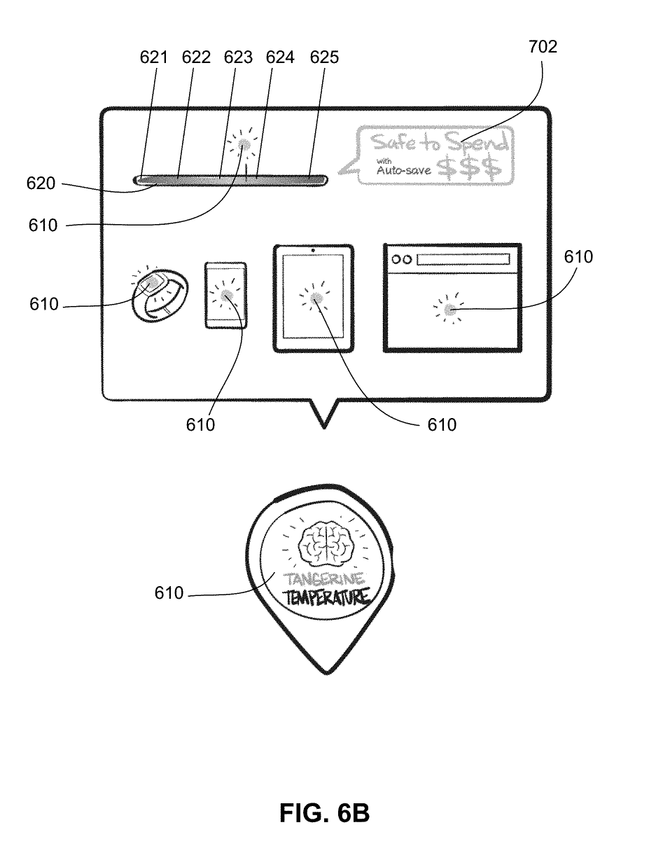

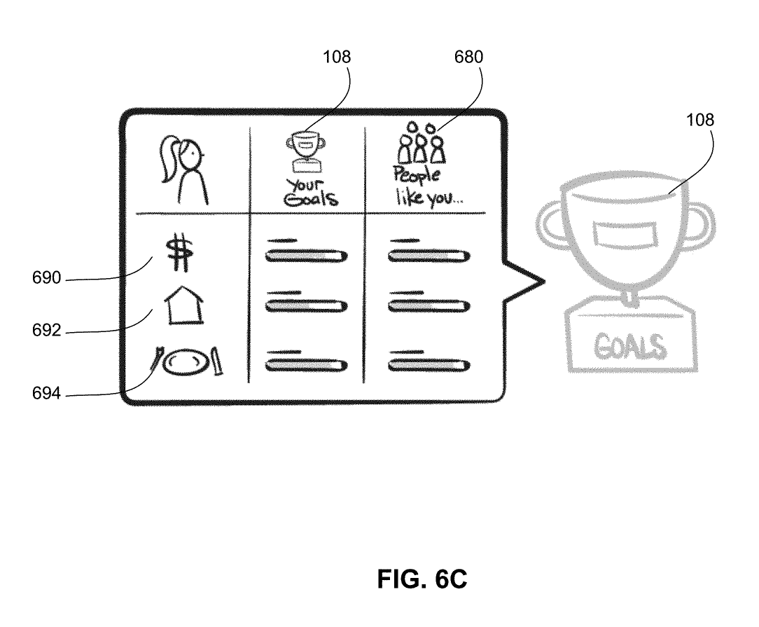

As previously mentioned, the profile engine 102 aggregates and analyzes all of the client profile data 150, questionnaire responses 152, news 154, and client community information 156. The profile engine 102 produces a single key performance indicator (KPI) 104, shown in further detail in FIG. 6A to FIG. 6C, which may be sent to the client device 205 and displayed on a display thereof. The KPI 104 is presented as a linear scale with increments that may be horizontal or presented as a chart. The KPI 104 presents a monthly budget goal 106 and one or more long-term goals 108 along a plan line 602. A plot of the client's actual financial position 604 may also be presented. The monthly budget goal 106 may be determined based on a client's goals. For example, with reference to FIG. 6A, the plan line 602 has a point in time 650 that represents the present time, and the plan line 602 is divided into segments 660 each representing a month. If, for example, the client has set a goal to purchase a car and the down payment required for the car is $3000, then the monthly budget 106 for each of the coming 6 months is adjusted so that the client may save $500 each month. The monthly savings is represented by the slope of plan line 602. FIG. 6A shows that line 604, which represents the client's actual financial position, has a lower slope than that of line 602 which indicates that the client is unable to meet their monthly budget savings goal. The KPI represents the delta between the planned financial position as depicted by plan line 602, and the actual financial position as depicted by actual financial position 604. The KPI 104 may be shown as a “temperature” scale that comprises a temperature color indicator 610 and a number 702 representing the amount that the client is “safe to spend” on a given day. The color is determined by a calculation of the difference between the actual financial position and the expected or planned financial position. The algorithm executing on the server 210 assigns a point on a green-yellow-red spectrum 620. The determined color may then be sent to the client device 205, for being displayed as a temperature color indicator 610. In one embodiment, the spectrum resembles a temperature scale with one end 621 being red, and the spectrum color changes gradually to orange at 622, yellow at 623, light green at 624, and dark green at 625. When the temperature is at the red end 621, then the client's actual financial position is significantly lower than the plan financial position. This may mean, for example, that the client has overspent in relation to their income by 25% or more. When the temperature is at the orange region 622, the client's current financial position is moderately lower than their plan financial position. This may mean, for example, that the client has overspent in relation to their income by between 10% and 25%. When the temperature is in the yellow region 623, the client has overspent by a trivial amount, such by 10% of their income. When the temperature is in the light green region the client is on target to meeting their goals, i.e. the current financial position is substantially equally to the plan financial position. When the temperature is in the dark green region, the client has a budget surplus, i.e. their current financial position is higher than the plan financial position. The color of the temperature indicator 610 can change at any time with real-time information. For example, account balances, credit card charges, scheduled payments and bills, are all monitored by the profile engine 102, and the information is used to update the color of the temperature indicator 610, so that the client is able to determine their financial temperature at a glance. The number 702 is a “safe to spend” amount and shows the amount the client is able to spend and still stay on track to meet future goals. If the client has overspent, the safe to spend number indicates how much the user has overspent by way of a delta between the client's actual behavior and the required or desired behavior in order to reach the goals. The KPI 104 may be presented in an application executing on a client device 205 as described further in detail below or may also be presented on wearable devices such as fitness trackers or watches.

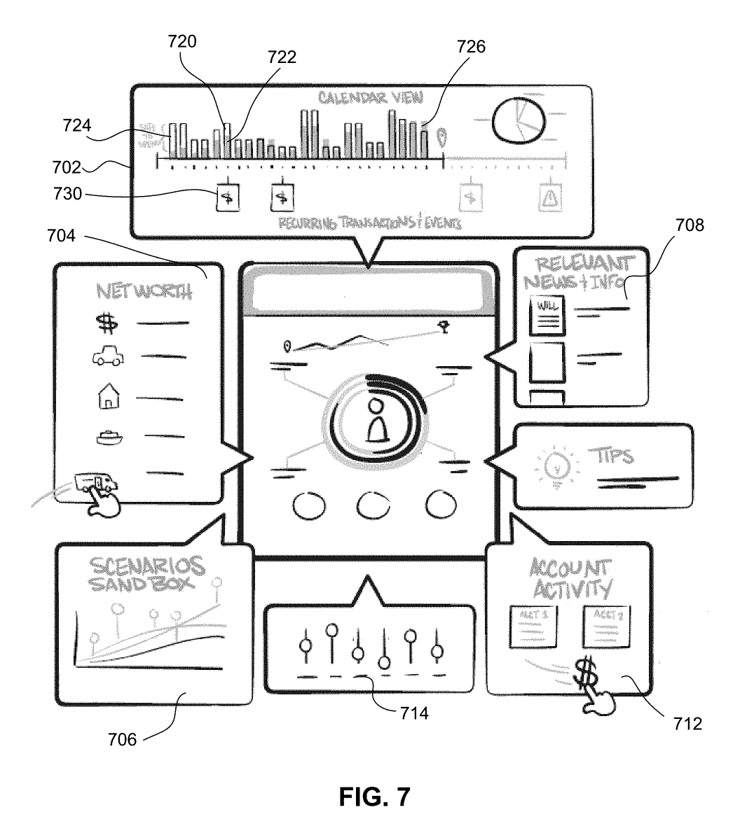

With reference to FIG. 6C, the KPI 104 may be initially based on suggested goals by the profile engine 102 based on goals set by people similar to the client 680. The more the client personalizes the customer profile data, the more accurate the KPI 104 becomes. The real-time temperature may be calculated based on one or more of at least: (1) agreed short and long term goals; (2) balancing goals with cash flow to reach a reasonable monthly target; (3) breaking down the monthly budget into a daily expected financial position taking into account forecasted cash flow events; and (4) displaying the difference between the actual financial position and expected position in the form of a temperature. The KPI 104 may be presented in dashboard 110, shown in more detail in FIG. 7 below. The temperature may be determined for different goals separately. For example, a client may have a goal 690 to save cash, a goal 692 to purchase a house, and a goal 694 to dine out at a certain place. The individual goals may be determined both for the client and for people similar to the client, and a temperature scale may be displayed for each goal, as see in FIG. 7.

The dashboard 110 allows the client quick access to their KPI 104 and may additionally display a calendar view 702 showing recurring transactions and events, a net worth 704, a scenario sandbox 706, relevant news and information 708, tips 710, account activity 712, and client communication customization controls 714. The dashboard 110 may be designed for particular use on a touch screen or other type of touch device. The calendar view 702 presents past client activity compared to the budget and may present recurring transactions and events in the future. The calendar view 702 presents information that the client may require to predict future cash flow. For example, the calendar view 702 can show the daily amount that the client may spend 720 and still meet their financial goals and have a balanced monthly budget, as well as the amount the client has actually spent 722. Both amounts can be shown on a single bar as part of a bar graph. If the amount spent 722 is less than the planned amount 720, then the client still has a safe to spend amount 724. If the client has spent more than the planned amount, the overspending daily amount 726 may be shown as a color extending outside the bar. As can be seen in the calendar view 702, daily amount that a client may spend 720 and still meet their financial goals is not constant. For example, recurring transactions 730 such as mortgage payments, car payments, utilities, cell phone plans, Internet, and cable can also impact the daily amount 720. For example, the daily amount 720 may be reduced for five days by $40 to allow for a recurring expense 730 of $200 to be deducted from a client's account, while keeping the client on track to meet their financial goals.

The net worth 704 view of dashboard 110 presents assets in an easy to read graphical format and may automatically appreciate or depreciate assets based on historical data. The dashboard 110 may also provide the client with a scenario sandbox 706 that allows the client to forecast different scenarios without committing to a course of action. Scenarios are compared to the current plan and the interface presented has levers and dials which allow the client to simulate hypothetical changes, such as salary increases, purchasing a more expensive vehicle, market fluctuations, or having additional children, and to see how these hypothetical changes impact financial choices and events. For example, increasing a salary increases the credits to one's bank account and therefore the daily amount 720 that the client may spend can increase. This may result in the color of the temperature indicator 610 being closer to the color green than it is to the color red. Alternatively, a cash saving goal 108 may be reached sooner with the higher salary. This may be represented by sliding the graphical representation of the goal on the plan financial position line 602 of the KPI towards the present time 650. The dashboard 110 presents news and relevant information 708 that provides a personalized stream of content and may comprise personally relevant financial news from local and global sources. This information may be obtained from the profile engine 102. Some of the content may be exclusive to the customer management system 100. The dashboard 110 may also present tips 710 that are generated by social analytical engines and crowd-sourced questions. All account activity 712 is presented where the user may add notes, tag transactions, and/or add comments on the transactions. The account activity 712 may also permit the user to validate and customize merchant category transaction labeling to better track spending patterns. For example, all restaurant purchases may be labeled as such for ease of identification. Future account actions may also be presented. The client may search account transactions based on the tags and user notes. The dashboard 110 may also permit taking photographs of receipts using the client device 205 for uploading into the account activity 712. Coupons may be applied directly within the system 100 to past or future purchases.

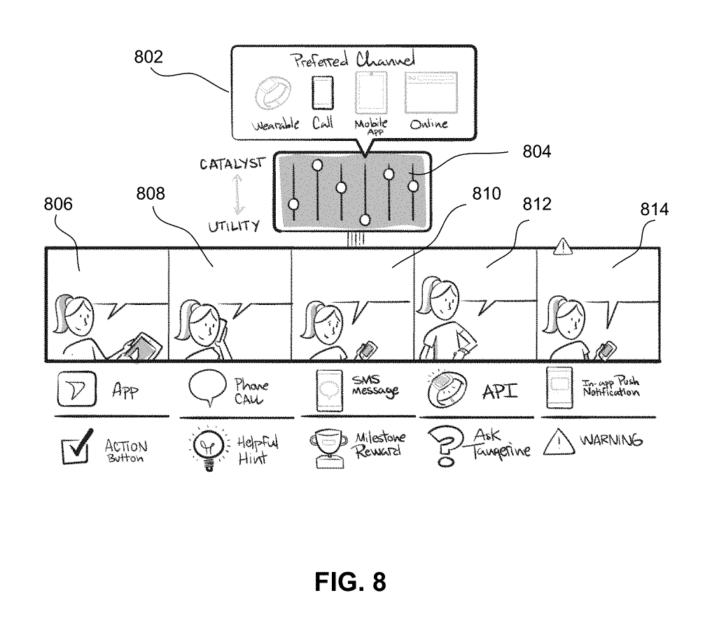

The customer management system 100 also comprises a client-communication customization engine 112, presented in more detail in FIG. 8, that enables the client to tailor prompts and notifications from the provider servers 210. As clients frequently have more than one type of computing device, the client may customize which notifications are received and how frequently notifications are received on each of their client devices 205. The client may select one or more preferred channel(s) 802 for communication. The alerts and notifications are provided at the correct time by tracking the client location and use of the particular client device 205. If too many notifications are being received, the client may reduce the number of notifications by sliding a slider 114 (e.g. six sliders 804) for that particular client device 205. The notifications are intelligently selected based on received client profile data. In one example, if the client checks the balance of an account every morning, the application prompts the user if the application should send a daily balance alert to one of their client devices 205.

A set of examples are presented in FIG. 8. In one example 806, prompts may be displayed prompting payment of a vehicle payment with a simple “Yes” or “No” prompt with an application executing on a mobile device. The profile engine 102 may also identify that funds in a retirement savings account could make more in a retirement savings mutual fund account and prompt for a transfer. In another example 808, the client is called on a mobile device and is provided with a hint such as “we noticed that you're off track to reach your goals, if we change your investment portfolio, we can get you back on track. Want us to make it happen?”. Another example 810 of an SMS notification may be indicating when the client has achieved a particular goal or milestone such as reaching a vacation savings goal and providing a free upgrade to first class as a reward.

The customer management system 100 may also respond to voice activated commands 812 on a wearable device such as asking it “can I afford a bike?” by way of a microphone and having the client device 205 provide a response or prompt for further questions (e.g. “what is your timeframe for purchase?”). The customer management system 100 may also express concerns 814 to the client such as when the client is running over on a particular budget item such as eating out in restaurants.

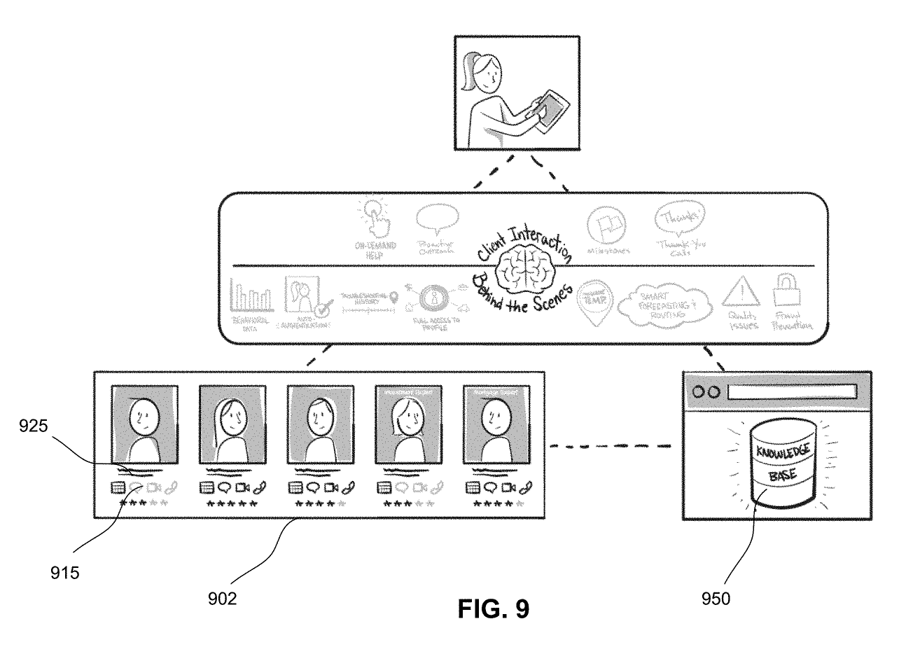

The customer management system 100 may also permit the client to customize his support services 116, as shown in more detail in FIG. 9. When the client interacts with customer support 116, the client profile data and troubleshooting history is made available to the customer service representative. Following each interaction with a customer service representative, the client is prompted to rate the experience. If a certain agent has received higher ranking by a particular client than other agents have, the client device 205 and provider server 210 will preferably route that client to that agent if available. When the client initiates an interaction, the client is presented with one or more customer service representatives 902 where each representative shows their previously ranking (by the particular client and/or a global ranking). The system 100 may present only customer service representatives 902 who have been previously ranked as 4 or 5 stars by the client. If none of the agents previously ranked as 4 or 5 stars by the client are available, the system may propose agents which have an average ranking of 4 or 5 stars by other client community members with similar profile data as the client. Each agent has available communication channels 915 such as phone, chat, video chat, or social media. Some agents may only be available by a few communication channels. Accordingly, if a client has selected a preferred channel 802, the system may present only customer service representatives who are available via the preferred channel selected for each of the client's devices. For example, a customer service representative 902 who is not available by phone may not be listed as an option to a customer who has selected that the phone is their preferred channel 802 on their smart phone. Conversely, if the client is using a laptop computer then they would have configured the preferred channel 802 for that device to be online chatting. In that instance only customer service representatives 902 available through online chatting are listed. The customer service representative may also have a profile 925 that lists their qualifications. The customer service representatives may navigate a knowledge base 950 that is the same as the one available to the client. This enables transparency in correcting and troubleshooting issues.

In one embodiment of the described customer management system 100, user interface components such as dashboard 110, temperature color indicator 610, and the interface component (e.g. sliders 114) of customer communication engine 112, may all be displayed as web interface components on a web browser running on client device 205. In another embodiment, dashboard 100, temperature indicator 610 and sliders 114 may be implemented in a client application running locally on client device 205.

As described with reference to FIG. 2, the client device 205 frequently communicates with the provider server 210 by way of a network. FIG. 2 demonstrates a system overview of a computing network 200 of the present embodiment. A user having a client device 205 such as a smartphone 202, a tablet computer 204, or laptop 206 in communication with a wireless access point 208 such as 3G, LTE, WiFi, Bluetooth®, near-field communication (NFC) or other wireless communication channels known in the art. The wireless access point 208 allows the client devices 205 to communicate with other devices over the Internet 250. In addition to the client devices 205, the system comprises one or more provider servers 210.

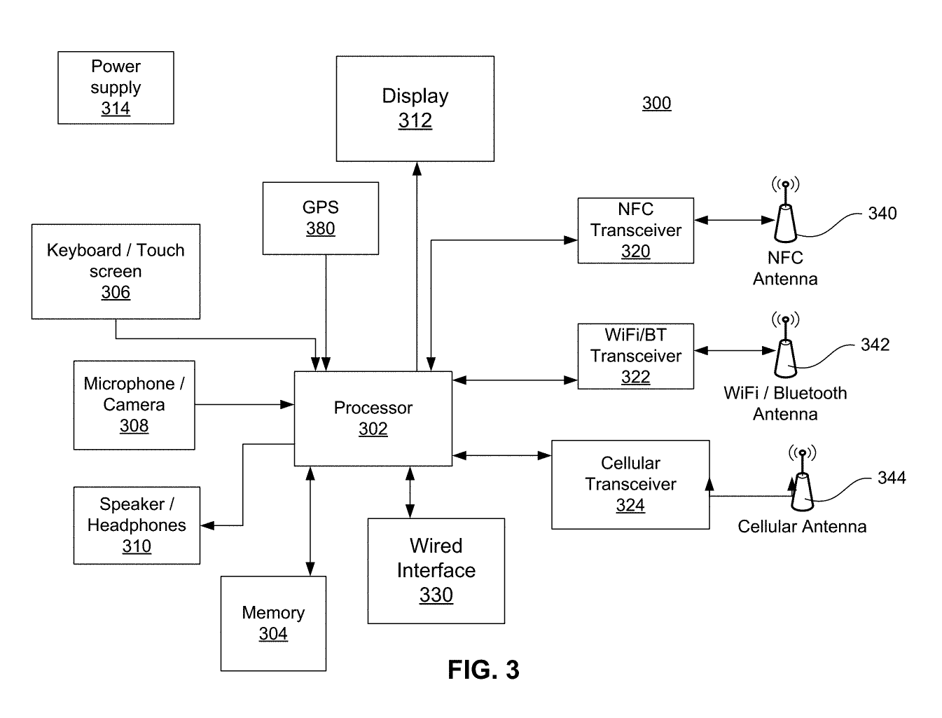

The components of an exemplary client device 205 are further disclosed in FIG. 3 having a processor 302 executing instructions from volatile or non-volatile memory 304 and storing data thereto. The exemplary client device 300 has a number of human-computer interfaces such as a keypad or touch screen 306, a microphone and/or camera 308, a speaker or headphones 310, and a display 312. The client device 300 has a battery 314 supplying power to all the components within the device. The battery 314 may be charged using a wired or wireless charging.

The keyboard 306 could be a conventional keyboard found on most laptop computers or a soft-form keyboard constructed of flexible silicone material. The keyboard 306 could be a standard-sized 101-key or 104-key keyboard, a laptop-sized keyboard lacking a number pad, a handheld keyboard, a thumb-sized keyboard or a chorded keyboard known in the art. Alternatively, the client device 300 could have only a virtual keyboard displayed on the display 312 and uses a touch screen 306. The touch screen 306 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 306 could be a single touch or multi-touch screen. Alternatively, the microphone 308 may be used for input into the client device 300 using voice recognition.

The display 312 is typically small size between the ranges of 1.5 inches to 14 inches to enable portability and has a resolution high enough to ensure readability of the display 312 at in-use distances. The display 312 could be a liquid crystal display (LCD) of any type, plasma, e-Ink®, projected, or any other display technology known in the art. If a touch screen 306 is present in the device, the display 312 is typically sized to be approximately the same size as the touch screen 306. The user controls the information displayed on the display 312 using either the touch screen or the keyboard 306. Alternatively, the client device 300 may not have a display 312 and rely on sound through the speakers 310 or other display devices to present information.

The client device 300 has a number of network transceivers coupled to antennas for the processor to communicate with other devices. For example, the client device 300 may have a near-field communication (NFC) transceiver 320 and antenna 340; a WiFi®/Bluetooth® transceiver 322 and antenna 342; a cellular transceiver 324 and cellular antenna 344 where at least one of the transceivers is a pairing transceiver used to pair devices. The client device 300 optionally also has a wired interface 330 such as USB or Ethernet connection. A Global Positioning System (GPS) module 380 is optionally included with client device 300 to be used for location tracking.

Turning now to the provider servers 210 and further described with reference to FIG. 3. The exemplary provider server 400 also has a processor 402 executing instructions from volatile or non-volatile memory 404 and storing data thereto. The provider server 400 may optionally have a keyboard or touch screen 306, and display 412. The provider server 400 may be communicated by way of a wired network adapter 424 such as Ethernet to communicate with the Internet 250. A wired power supply 414 provides power to all the components of the provider server 400. The provider server 400 may have a wired interface 430 such as USB for connection to and communication with other devices such as the mobile device 300. The provider server 400 may be used to implement the processes described herein, including the client-side and server-side processes for installing a computer program.

Provider server 400 is intended to represent various forms of digital computers, such as laptops, desktops, workstations, personal digital assistants, servers, blade servers, mainframes, and other appropriate computers. Client devices 205 are intended to represent various forms of mobile devices, such as personal digital assistants, tablets, cellular telephones, smartphones, and other similar computing devices. The components 300 shown here, their connections and relationships, and their functions, are meant to be exemplary only, and are not meant to limit implementations of the inventions described and/or claimed in this document.

The provider server 400 may be implemented in a number of different forms, as shown in the figures. For example, it may be implemented as a standard server, or multiple times in a group of such servers. It may also be implemented as part of a rack server system. In addition, it may be implemented in a personal computer such as a laptop computer.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

The above-described embodiments are intended to be examples of the present invention and alterations and modifications may be effected thereto, by those of skill in the art, without departing from the scope of the invention, which is defined solely by the claims appended hereto.

What is claimed is:

1. A method of improving customer management system, comprising:
retrieving financial data, for a customer, from a plurality of sources;
presenting a questionnaire to the customer and receiving responses to the questionnaire including financial goals;
generating a key performance indicator, based on the financial data and the financial goals, the key performance indicator comprising a plan financial position line and an actual financial position line, on a time scale between a present time and a time associated with one of said financial goals;
generating a temperature color indicator representing a difference between the actual financial position and the planned financial position; and
determining a monthly budget based on a duration between the present time and the time associated with the one of said financial goals.

2. The method of claim 1, wherein the questionnaire is generated based on missing information in the financial data.

3. The method of claim 1, further comprising sending login credentials to a plurality of online financial websites for gaining access thereto for retrieving the financial data.

4. The method of claim 1, wherein the temperature color indicator:
displays red when the actual financial position is significantly lower than the plan financial position;
displays orange when the actual financial position is moderately lower than the plan financial position;
displays yellow when the actual financial position is trivially lower than the plan financial position;
displays light green when the actual financial position is substantially equal to the plan financial position; and
displays dark green when the actual financial position is higher than the plan financial position.

5. The method of claim 4, wherein the receiving of financial data is repeated periodically in real-time, and wherein the temperature color indicator is updated based on the financial data.

6. The method of claim 1, further comprising displaying a calendar view including:
a plurality of planned daily spending amounts;
a plurality of actual daily spending amounts; and
one or more recurring transactions.

7. The method of claim 6 wherein the plurality of planned daily spending amounts are based on the monthly budget and on the one or more recurring transactions.

8. The method of claim 6, wherein the plurality of planned daily spending amounts and the plurality of actual daily spending amounts are displayed as bar graphs.

9. The method of claim 1, further comprising displaying a scenario sandbox, including at least one slider control for increasing income, and wherein a graphical representation of the financial goals may be slid towards the present time on the plan financial position line.

10. The method of claim 1, further comprising:
receiving and storing the customer's preferred mode of communication with a customer service representative;
receiving and storing a rating by the customer rating of one or more of a plurality of customer service representatives; and
when the customer contacts customer service, he is presented with a choice of customer service representatives based on:
the available mode of communication that one or more of the plurality of customer service representatives supports; and
the rating by the customer of each of the one or more of the plurality of customer service representatives.

11. A system for improving performance of a customer management system, comprising:
an electronic network in communication with a client computing device and a provider server;
the provider server comprising:
a wired transceiver in communication with the network; and
a provider processing structure reading and executing instructions from a computer-readable medium, the instructions comprising a profile engine that:
retrieves financial data for a customer from a plurality of sources;
sends a questionnaire for display on the client computing device;
receives, from the client computing device, responses to the questionnaire including a plurality of financial goals;
generates a key performance indicator based on the financial data and the financial goals, comprising a plan financial position line and an actual financial position line, on a time scale between a present time and a time associated with one of the plurality of financial goals;
generates a temperature color indicator representing a difference between the actual financial position line and the plan financial position line; and
determines a monthly budget based on a duration between the present time and the time associated with the one of the plurality of financial goals; and
the client computing device comprising:
a network transceiver in communication with the network; and
a client processing structure reading and executing instructions from a computer-readable medium, the instructions comprising:
instructions for receiving and displaying the questionnaire;
instructions for obtaining, from the customer, responses to the questionnaire and transmitting the responses to the provider server over the network;
instructions for displaying the key performance indicator; and
instructions for displaying the temperature color indicator.

12. The system of claim 11, wherein the profile engine generates the questionnaire based on missing information in the financial data.

13. The system of claim 11, wherein the profile engine sends login credentials to a plurality of online financial websites for gaining access thereto for retrieving the financial data.

14. The system of claim 11, wherein displaying the temperature color indicator comprises:
displaying red when the actual financial position is significantly lower than the plan financial position;
displaying orange when the actual financial position is moderately lower than the plan financial position;
displaying yellow when the actual financial position is trivially lower than the plan financial position;
displaying light green when the actual financial position is substantially equal to the plan financial position; and
displaying dark green when the actual financial position is higher than the plan financial position.

15. The system of claim 11, wherein the profile engine retrieves financial data periodically in real time and wherein displaying the temperature color indicator further comprises updating the temperature color indicator based on the financial data.

16. The system of claim 11, wherein the instructions executed on the client computing device further comprise instructions for displaying a calendar view, including:
a plurality of planned daily spending amounts;
a plurality of actual daily spending amounts; and
one or more recurring transactions.

17. The system of claim 16, wherein the plurality of planned daily spending amounts are based on the monthly budget and based on the one or more recurring transactions.

18. The system of claim 16, wherein the plurality of planned daily spending amounts and the plurality of actual daily spending amounts are displayed as bar graphs.

19. The system of claim 11, wherein the instructions executed on the client computing device further comprise instructions for displaying a scenario sandbox including at least one slider control for increasing income, and wherein a graphical representation of the financial goals may be slid towards the present time on the plan financial position line

20. The system of claim 1, wherein the profile engine further:
receives and stores the customer's preferred mode of communication with a customer service representative;
receives and stores a rating by the customer of one or more of a plurality of customer service representatives; and
wherein instructions executed on the client computing device further comprise instructions for presenting the customer with a choice of customer service representatives based on:
the available mode of communication that each one or more of the plurality of customer service representatives supports; and
the rating by the customer of the one or more of the plurality of customer service representatives.
